(19) United States
(12) Patent Application Publication
(10) Pub. No.: US 2026/0254336 A1
(43) Pub. Date: Aug. 27, 2026

(54) MINIATURE DC ELECTROMAGNETIC PUMPS OF HEAVY AND ALKALI LIQUID METALS AT UP TO 500 °C FOR NUCLEAR AND INDUSTRIAL APPLICATIONS

(71) Applicant: UNM Rainforest Innovations, Albuquerque, NM (US)

(72) Inventors: Mohamed S. EL-GENK, Albuquerque, NM (US); Ragai ALTAMIMI, Albuquerque, NM (US)

(73) Assignee: UNM Rainforest Innovations, Albuquerque, NM (US)

(21) Appl. No.: 19/125,300

(22) PCT Filed: Oct. 27, 2023
(86) PCT No.: PCT/US2023/078127

§ 371 Date: Apr. 28, 2025

Related U.S. Application Data
(60) Provisional application No. 63/420,062, filed on Oct. 27, 2022.

(51) Int. Cl. H02K 44/04; F04B 15/04

(52) U.S. Cl. CPC H02K 44/04; F04B 15/04

(57) ABSTRACT

Provided are pumps for circulating heavy and alkali liquid metals at below 500° C. without active cooling. A direct current miniature and submersible electromagnetic (DC-EM) pump includes a rectangular flow duct, a pair of magnets located on opposing sides of the rectangular flow duct and a pair of electrodes located on opposing sides of the rectangular flow duct that do not have the magnets. When a current is applied to the electrodes, an electrically conductive fluid flows through the rectangular flow duct by using generated Lorentz forces in a direction perpendicular to the magnetic field flux density created by the opposingly located magnets and a DC electrical current created by the electrodes.

### RELATED APPLICATIONS

This application claims priority to U.S. Provisional Application No. 63/420,062, filed on Oct. 27, 2022, which is incorporated herein in its entirety.

### STATEMENT REGARDING FEDERALLY SPONSORED RESEARCH & DEVELOPMENT

This invention was made with government support by the U.S. Department of Energy grant DE-AC07-051D14517. The government has certain rights in the invention.

### BACKGROUND OF THE INVENTION

The present invention concerns pumps for circulating heavy and alkali liquid metals at <500° C. without active cooling.

### BRIEF SUMMARY OF THE INVENTION

In one aspect, the present invention concerns designs of miniature, submersible DC-EMP with diameters ranging from 57 mm to 133.5 mm for use in ex-pile or in-pile test loops of heavy and alkali liquid metals at temperatures ≤500° C., liquid metals cooled advanced nuclear and microreactors for electricity generation and the production of high-temperature process heat.

In other aspects, the present invention concerns a design of submersible, dual-regions, miniature Direct Current Electromagnetic (DC-EM) pumps of different diameters for passively circulating heavy and alkali liquid metals at ≤500° C. without active cooling. Potential applications include ex-pile and in-pile test loops to support the materials and nuclear fuel developments for Gen-IV sodium and molten lead fast nuclear reactors and various industrial and mining applications.

In yet other aspects, the present invention concerns a pump design with two pumping regions, compared to designs with a single pumping region, while having diameters of 57 mm, 66.8 mm, 95.4 mm, and 133.5 mm in diameter. The embodiment employs two Alnico 5 permanent magnets with Hiperco-50 pole pieces for focusing the magnetic field lines in the flow duct. For molten lead at 500° C., the pumping power increases from 368 W to 728 W, and the peak efficiency from 14.7% to 31.6% with increased pump diameter from 57 mm to 133.5 mm. For liquid sodium, the pumping power and peak efficiency are higher, increasing from 392 W to 767 W and from 44.3% to 51.2%, respectively, with increased pump diameter from 57 mm to 133.5 mm.

In other embodiments, the present invention provides designs of miniature, submersible DC-EM pumps with diameters ranging from 57 mm to 133.5 mm for use in ex-pile or in-pile test loops of heavy and alkali liquid metals at temperatures ≤500° C. The determined dimensions for achieving the highest cumulative pumping power and peak efficacy provide choices to potential users including those in the liquid metals and metals mining industries, liquid metals cooled nuclear advanced and microreactors for electricity generation and the production of high-temperature process heat.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily to scale, like numerals may describe substantially similar components throughout the several views. Numerals having different letter suffixes may represent different instances of substantially similar components. The drawings illustrate generally, by way of example, but not by way of limitation, a detailed description of certain embodiments discussed in the present document.

FIG. 1 provides schematics of the operation principle of a DC-EMP for an embodiment of the present invention.

FIG. 2A shows the shapes of permanent magnets for DC-EM pumps.

FIG. 2B show the shapes of horseshoe permanent magnets for DC-EM pumps.

FIG. 3 shows the temperature demagnetization of Alnico 5 permanent Magnet.

FIG. 4 are demagnetization curves of permanent magnet materials.

FIG. 5A shows the arrangement of the Alnico 5 magnets without pole pieces.

FIG. 5B shows, for an embodiment of the present invention, the arrangement of the Alnico 5 magnet with Hiperco-50 pole pieces.

FIG. 6 shows the calculated magnetic flux distributions produced by the Alnico 5 magnets: (a) without pole pieces, and (b) with Hiperco-50 pole pieces, at zero flow of molten lead at 500° C. for representative dimensions of the developed miniature DC-EM pump design (FIG. 6).

FIG. 7: Calculated axial distribution of magnetic field flux density at zero flow molten lead at 500° C. in a miniature, dual regions 66.8 mm diameter miniature DC-EM pump.

FIG. 8 shows the calculated distributions of the electrical current at zero molten lead flow in the miniature dual regions of 66.8 mm diameter miniature DC-EM pump.

FIG. 9A is an isometric view of a miniature DC-EM pump design with two pumping regions of heavy and alkali liquid metals at <500° C.

FIG. 9B is an elevation view of a miniature DC-EM pump design with two pumping regions of heavy and alkali liquid metals at <500° C.

FIG. 9C is a cross-sectional view of a miniature DC-EM pump design with two pumping regions of heavy and alkali liquid metals at <500° C.

FIG. 9D is a plane view A-A of a miniature DC-EM pump design with two pumping regions of heavy and alkali liquid metals at <500° C.

FIG. 10 shows comparisons of achievable PPₚₑₐₖ and ηₚₑₐₖ by the miniature, dual regions miniature DC-EMPs of different diameters for molten lead and liquid sodium at 500° C.

### DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

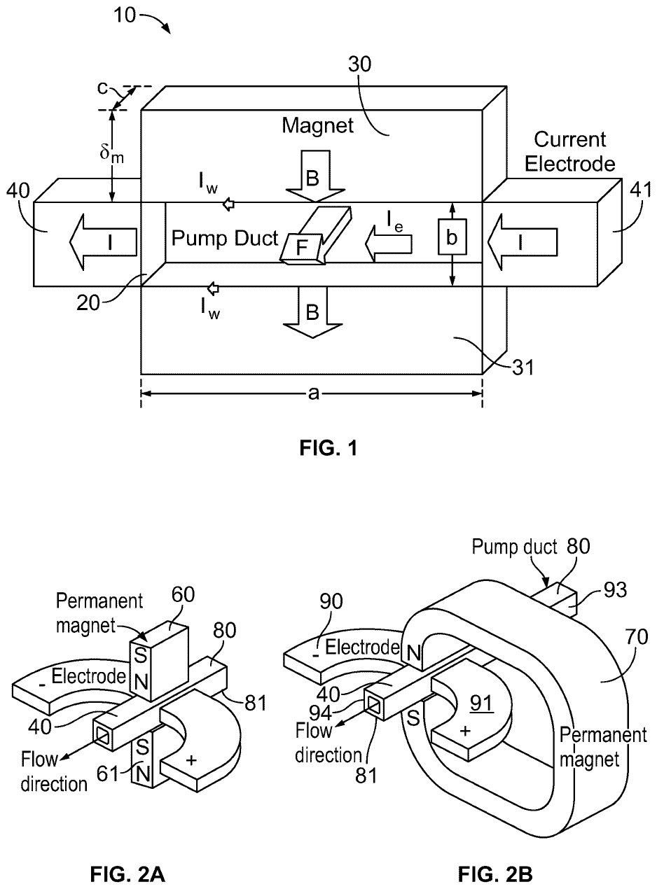

As shown in FIG. 1, DC-EM pump 10 drives the flow of an electrically conductive liquid through a rectangular duct 20 using the generated Lorentz force (FL) in the perpendicular direction to those of the magnetic field flux density (B) created by opposingly located magnets 30-31 and the DC electrical current (I) supplied by electrodes 40-41 in the flow duct 20.

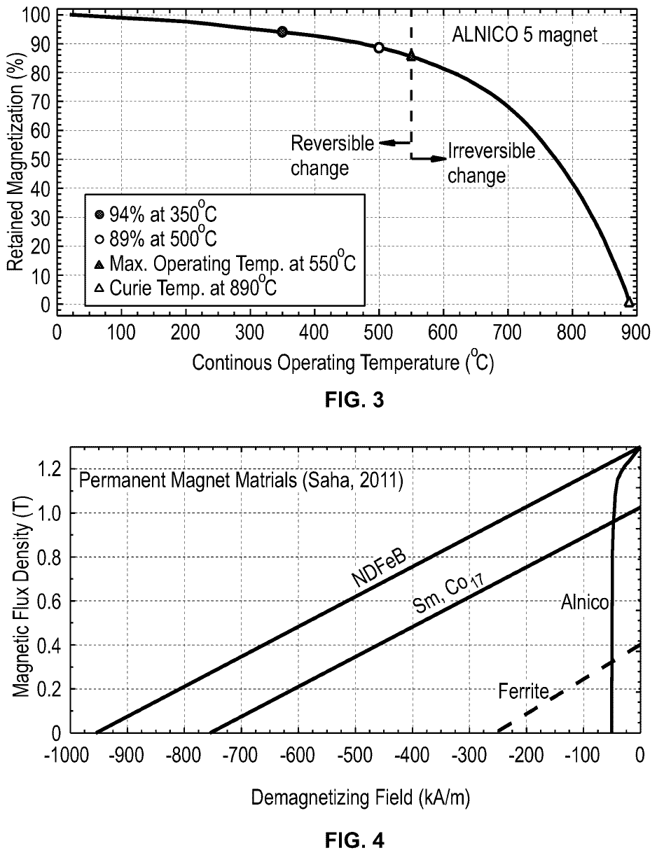

As shown in FIGS. 2a and 2b, the magnetic field flux density (B) is produced either by opposing permanent magnets 60-61 or by an electro-magnet 70 mounted on the wide sides 80-81 of the flow duct (ac) and the electrical current is provided by two electrodes 90-91 mounted on the narrow sides 93-94 of duct 40. The DC-EM pump may employ a pair of rectangular permanent magnets with a similar magnetizing direction (FIGS. 2a and 3a), or a horseshoe-type magnet (FIGS. 2b and 3b).

The generated magnetic flux density in the pump duct by a pair of rectangular magnets minus the magnet flux losses contribute to the generation of Lorentz force. With horseshoe permanent magnets, the majority of generated magnetic field passes through the flowing fluid in the pump duct with minimal loss to the surroundings. However, these magnets are large to use in miniature or small diameter DC-EM pumps.

To develop submersible miniature DC-EM pump designs for circulating molten lead and liquid sodium at temperatures of up to 500° C., dimensions and materials of the permanent magnets and of the flow duct are selected. Among commercially available materials for permanent magnets, Alnico alloys, with 8-12 wt. % aluminum (Al), 15-26 wt. % nickel (Ni), 5-24 wt. % Cobalt (Co), up to 6 wt. % Copper (Cu), up to 1 wt. % Titanium (Ti), and the rest iron (Fe), have temperature stability and capable of operating at temperatures exceeding 500° C. The Alnico 5 alloy comprised of 8% Al, 14% Ni, 24% Co, 3% Cu copper, and the balance of 51% Fe, is widely used due to its magnetic remanence and energy product (BH)ₘₐₓ. In addition, at 500° C., Alnico 5 magnets maintain 89% of their residual magnetic field strength at room temperature and experience no permanent reduction of magnetization strength up to 550° C. (FIG. 3). Further increase in temperature, however, irreversibly decreases the magnetic field strength until reaching the curie point of 890° C. at which the magnet becomes paramagnetic.

Despite their magnetic stability at elevated temperatures and magnetic field strength, Alnico magnets have a low coercive force compared to other permanent magnets and a sharp decrease in the B-H curve after the knee point (FIG. 4). Therefore, to avoid self-demagnetization the magnet's effective length-to-diameter ratio, and consequently, the permeance coefficient (P_{c}=B/H) needs to be large enough to operate above the knee of its demagnetization curve. For best performance, the length of the Alnico 5 magnet is recommended to be 4 to 5 times the pole equivalent diameter. Thus, using Alnico 5 permanent magnets in typical DC-EM pump designs will increase the pump diameter, beyond those of the present miniature pumps for circulating heavy and alkali liquid metals.

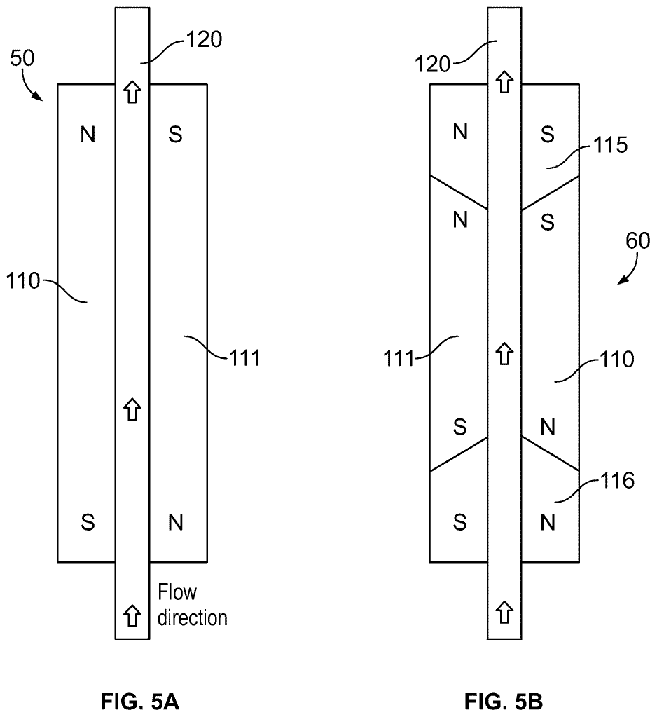

To comply with recommended aspect ratio of the Alnico 5 magnets, the developed designs of the miniature DC-EM pump of the embodiments of the present invention, FIG. 5a shows miniature DC-EM pump 50 having Alnico 5 magnets 110 and 111 with t pole pieces for an embodiment of the present invention. FIG. 5b shows miniature DC-EM pump 60 having an arrangement of Alnico 5 magnets 110 and 111 with Hiperco-50 pole pieces 115-116.

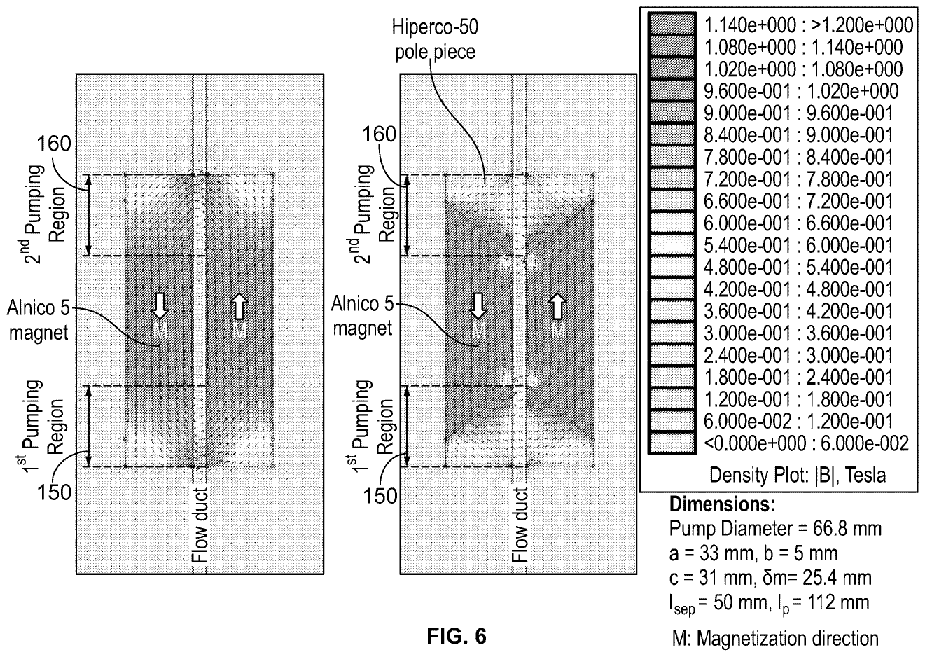

As further shown in FIGS. 5a and 5b, the two Alnico 5 permanent magnets 110-111 have opposite magnetizing directions along the length of the rectangular flow duct 120. This arrangement satisfies the magnets' effective length to equivalent diameter to minimize self-demagnetization. In addition, the present miniature DC-EM pump designs of the present invention have small diameters and two successive pumping regions 150 and 160, as shown in FIG. 6. For the same flow direction along the pump duct, the magnetic flux density, and the electrodes electrical current in the two pumping regions are in opposite directions. The magnetic field lines in the two pumping regions of the DC-EM pump extend between the two magnet poles and across the liquid metal flow duct in a perpendicular direction to both those of the electric current and the induced liquid flow (FIGS. 5, 6).

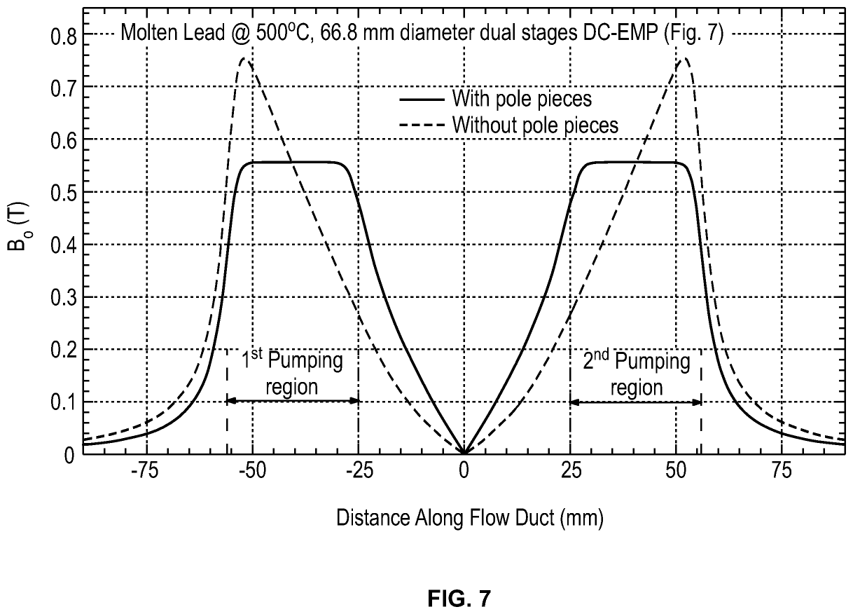

FIG. 6a presents the calculated distribution of the generated magnetic flux by the Alnico 5 magnets using the FEMM software for zero molten lead flow at 500° C. in 66.8 mm diameter pump of the developed design (FIGS. 5a and 5b). The generated magnetic flux densities in the two pumping regions are similar but not uniform with a large part traveling outside the pump duct. This decreases the produced Lorentz force for driving the liquid metal flow in the pump duct. However, attaching pole pieces 115 and 116 of high magnetic permeability material at both ends of the Alnico 5 magnets (FIG. 5b, 6b) redirect and focus the magnetic field lines across the flow duct and reduce losses to the surrounding (FIG. 6b). A choice for pole pieces material is Hiperco-50, which has one of the magnetic permeabilities of commercially available soft magnets, and a curie point of ~940° C. With Hiperco-50 pole pieces 115-116 attached to Alnico 5 magnets 110-111, the magnetic field lines travel in straight lines and at uniform flux densities across the flow duct in the two pumping regions, which help improve the pump performance (FIGS. 6b, 7). As indicated in FIG. 7, the calculated effective magnetic flux densities using the FEMM software for stagnant molten lead in the pump duct at 500° C. are uniform in the two pumping regions. This suggests that the generated Lorentz force in the two pumping regions and the performance of the present pump designs using Alnico 5 permanent magnets with Hiperco-50 pole pieces (FIG. 5b) would be higher than without the pole pieces (FIG. 5a).

The calculated axial distributions of the magnetic flux density using the FEMM software in the flow duct center of the miniature dual regions DC-EM pump (FIG. 7) confirm the effectiveness of the Hiperco-50 pole pieces in redirecting and focusing the magnetic field across the duct (FIG. 6b). These distributions are the same in the two pumping regions, dropping to zero at mid-point of the separation distance between the current electrodes. The magnetic flux density in the flow duct in the two pumping regions is almost uniform when attaching Hiperco-50 pole pieces and drops rapidly outside these regions. Such drops represent a small loss which does not contribute to the generated Lorentz force in the duct within the two pumping regions (FIGS. 6b, 7). The total pumping pressure is the sum of those produced by the Lorentz force in the two pumping regions.

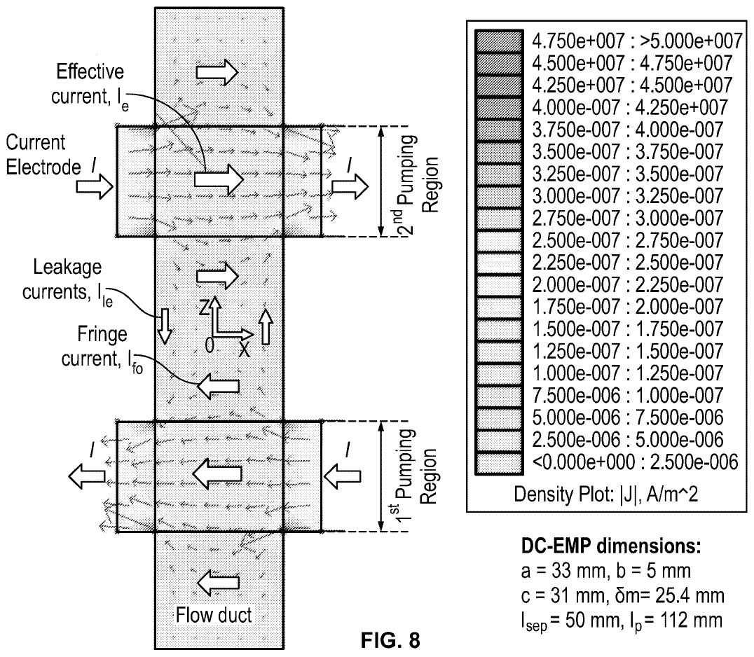

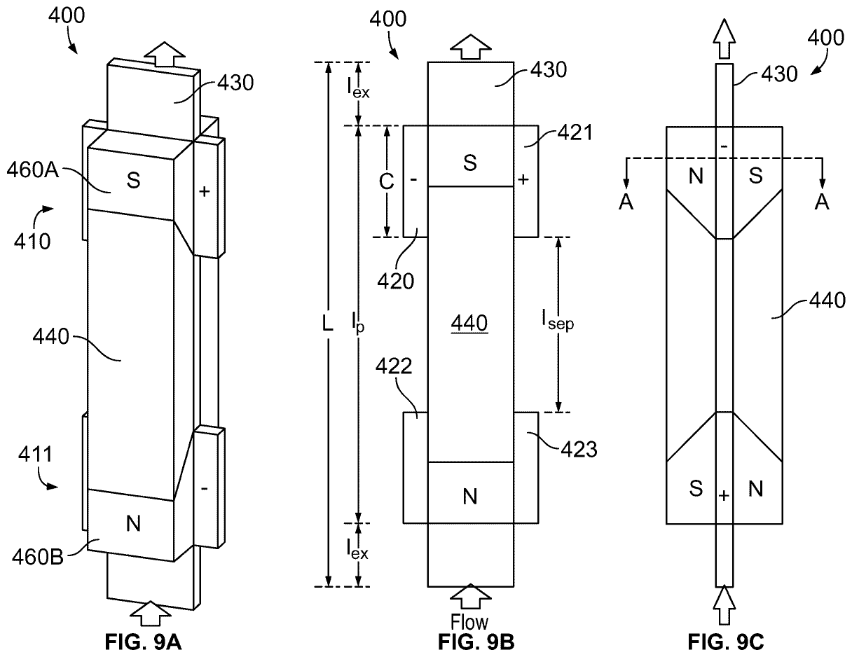

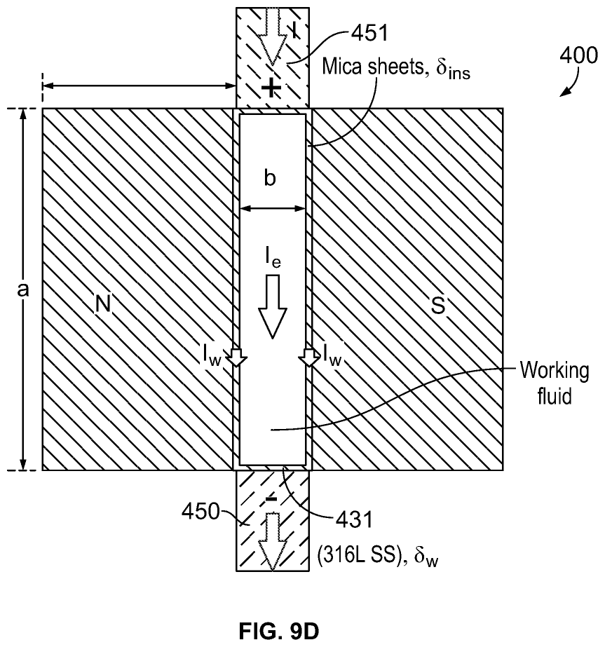

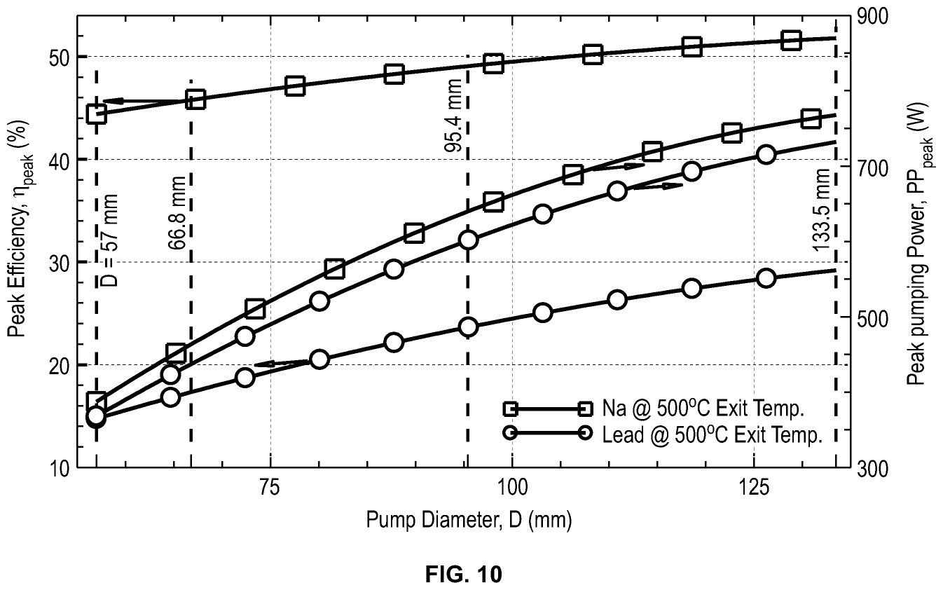

As delineated in FIG. 8, the developed miniature, the dual regions DC-EM pump designs (FIGS. 9a-d) experience electrical current leakage (Iₗₑ) or exchange between the electrodes in the two pumping regions. FIG. 8 presents the calculated electric current distribution using the FEMM software in the pump duct for zero molten lead flow at 500° C. The leakage current, Iₗₑ, from pumping region 2 to the lower pumping region 1 combines with the main current exiting the electrode. Similarly, the leakage current from pumping region 1 flows upward and combines with the electrical current exiting the electrode in pumping region 2 (FIG. 8). The leakage currents decrease the effective current (Iₑ) flowing across the flow duct in the two pumping regions and hence the pumping pressure and the performance of the pump. The magnitudes of the leakage currents are inversely proportional to the separation distance (lₛₑₚ) between the current electrodes in the two pumping regions (FIG. 10), which also depends on the total length of the two Alnico 5 magnets. Therefore, the separation distance between the two pumping regions, Iₛₚ, in the present design of the miniature DC-EM pumps of different diameters needs to be large enough to minimize the leakage currents without excessively increasing the total length of the pump, L (FIGS. 9a-d).

For the 66.8 mm diameter miniature DC-EM pump analyzed, the calculated percentage of the leakage currents from input current of 3.5%, is considered losses as it does not contribute to the generated Lorentz force in the pump duct (FIG. 8). Only 65% of the pump input current travels across the flow duct in the two pumping regions and contributes to the generation of the Lorentz force for driving molten lead flow through the pump duct and hence the generated pumping pressure (FIG. 8). In addition, the calculated fringe currents, Ifo, upstream and downstream of the two pumping regions, which represent 31.5% of the input electrode currents, are also losses since they do not contribute to the generated Lorentz force in the two pumping regions.

FIGS. 9a-d present views of submerged miniature DC-EM pump 400 with two pumping regions 410-411 for molten lead and liquid sodium at <500° C. and without active cooling. The length of the two pumping regions equals that of the current electrodes 420-423. The entrance and exit extensions of the rectangular flow duct 430, each is lₑₓ long, help produce a uniform and hydraulically developed liquid flow in the pump duct and minimize the flow entrance and exit effects, and hence, the total pressure losses along the pump duct. In the first and second pumping regions, the magnetic field generated by the Alnico 5 magnets 440 and the supplied electrical currents in perpendicular directions produce the Lorentz force for driving the flow. The length of the flow duct between the two pumping regions equals the separation distance, lₛₑₚ, between the two current electrodes and affects the magnitudes of the effective currents in the pumping regions, Iₑ, and the leakage currents, Iₗₑ, exchanged between the two regions (FIGS. 8, 9). The contribution to the Lorentz force and the pumping pressure by the interaction of the fringe currents and fringe magnetic fields is negligible.

The magnet structure in the second pumping region has an opposite polarity and magnetic flux direction to those in the first pumping region (FIGS. 6b, 9c). Similarly, the electrical currents in the two regions are supplied in opposite directions so that the generated Lorentz force acts in the flow direction (FIGS. 8, 9b). The dimensions of the flow duct 430 (length (c), width (a), and depth (b)), and the thickness of the duct wall 431, δ_{w}, in the two pumping regions of the present design of miniature DC-EM pumps 400 are the same (FIG. 9d). The thickness of the electrical insulation 450-451 (δᵢₙₛ) between the flow duct 430 and the Hiperco-50 pole pieces 460A and 460B and Alnico 5 magnets 440 minimize the distortion and the decrease in the magnetic flux density across the flow duct and the decrease in the effective electric current due to the induced opposing electromagnetic force due to the liquid flow in the generated magnetic field.

In addition to the Alnico 5 permanent magnets 440 with Hiperco-50 pole pieces 460A and 460B, other selected materials are 316L stainless steel for the walls of the flow duct 431 and the pump casing and support structure, Copper 101 for the current electrodes, and Mica sheets for electrically insulating the Alnico 5 magnets and Hiperco-50 pole pieces from the duct wall. These materials are compatible with Molten lead and sodium at temperatures of ≤500° C. and have desirable thermophysical properties. The 316L stainless steel has good corrosion resistance and weldability. Copper 101 used as the electrode as it has one of the electrical and thermal conductivities at elevated temperatures of commercially available electrical conductors' materials. It is easy to machine and cold work and suitable for electric current densities at elevated temperatures. Finally, the Mica sheets 450 and 451 have electrical resistivity and can withstand currents at elevated temperatures.

TABLE 1
Dimensions of the miniature dual regions DC-EM pumps of different
diameters for the highest cumulative pumping power (PP_{cu}) and peak
efficiency, ηₚₑₐₖ of molten lead at 500° C.

| | D | Optimized Dimensions (mm) | | | | | | PPₚₑₐₖ | ηₚₑₐₖ | Qᵣₒ |
|---|---|---|---|---|---|---|---|---|---|---|
| Criterion | (mm) | b | δₘ | a | c | Lₛₑₚ | Lₚ | (W) | (%) | (m³/hr) |
| Highest | 57 | 5 | 20.4 | 31 | 30 | 43 | 103 | 368 | 9.6 | 10.8 |
| PP_{cu} | 66.8 | 5 | 25.4 | 33 | 31 | 50 | 112 | 437 | 11.3 | 11.4 |
| | 95.4 | 5 | 40.3 | 38 | 37 | 65 | 139 | 604 | 15.4 | 12.2 |
| | 133.5 | 5 | 59.3 | 45 | 50 | 72 | 172 | 728 | 18.3 | 12.9 |
| Highest | 57 | 8.6 | 21.8 | 17.2 | 73 | 87 | 233 | 145 | 14.7 | 7.7 |
| ηₚₑₐₖ | 66.8 | 8.7 | 26.8 | 17.3 | 54 | 63 | 171 | 181 | 17.4 | 8.0 |
| | 95.4 | 8.9 | 41.4 | 17.6 | 62 | 79 | 203 | 247 | 24.6 | 8.7 |
| | 133.5 | 9 | 60.6 | 18 | 75 | 91 | 241 | 319 | 31.6 | 8.9 |

TABLE 2
Dimensions of the miniature, dual regions DC-EM pumps of different diameters
for the highest PPcu, and ηpeak of liquid sodium at 500° C.

| | D | Optimized Dimensions (mm) | | | | | | PPₚₑₐₖ | ηₚₑₐₖ | Qᵣₒ |
|---|---|---|---|---|---|---|---|---|---|---|
| Criterion | (mm) | b | δₘ | a | c | Lₛₑₚ | Lₚ | (W) | (%) | (m³/hr) |
| Highest | 57 | 5 | 23.6 | 17.1 | 35 | 40 | 110 | 392 | 34.0 | 10.7 |
| PP_{cu} | 66.8 | 5 | 28.3 | 19.1 | 46 | 51 | 143 | 456 | 36.5 | 11.4 |
| | 95.4 | 5 | 42.8 | 22.4 | 59 | 74 | 192 | 643 | 39.1 | 11.9 |
| | 133.5 | 5 | 61.9 | 26.2 | 72 | 82 | 226 | 767 | 40.2 | 12.6 |
| Highest | 57 | 5.6 | 24.1 | 11.1 | 52 | 55 | 159 | 312 | 44.3 | 9.0 |
| ηₚₑₐₖ | 66.8 | 5.7 | 29.0 | 11.6 | 57 | 61 | 175 | 349 | 45.9 | 9.5 |
| | 95.4 | 6.0 | 43.3 | 12.0 | 65 | 76 | 206 | 446 | 48.7 | 10.4 |
| | 133.5 | 6.4 | 62.2 | 12.8 | 75 | 91 | 241 | 526 | 51.2 | 10.8 |

For the different miniature pump diameters, the values of the peak pumping power, PPₚₑₐₖ, for liquid sodium are ~5%-7% higher and those of the peak efficiency, ηₚₑₐₖ, are ~75% to 200% higher than for molten lead (Tables 1 and 2, and FIG. 10). Furthermore, for the same pump diameter, the flow duct cross-sectional areas for pumping liquid sodium are smaller than for molten lead, including those for achieving the highest cumulative pumping power, PP_{cu}, and ηpeak. Conversely, for the same diameters, the lengths of the pumps for liquid sodium and the dimensions for the highest PP_{cu} and ηₚₑₐₖ are both higher than for pumping molten lead at 500° C. (Tables 1 and 2).

The pump dimensions for achieving the highest PP_{cu} produce higher pumping pressures and runout flow rates than those for the highest ηₚₑₐₖ. The small duct height (b) and large magnet thickness (δₘ) in these pumps increase the magnetic flux density, Bₒ, and hence the pumping pressure. In addition, the large duct width (a) increases the duct flow area and the runout flow rate (Qᵣₒ). Also, the decreased pressure losses increase the net pumping pressure. Increasing the width of flow duct, a, increases the pump efficiency and decreases the terminal voltage, E, needed to provide the specified electrodes current of 3,500 ADC. Increasing the length of the current electrodes, c, and the separations distance, Lₛₑₚ, between the two pumping regions (FIG. 9) increase the effective electrical current in the flow duct by decreasing the fringe and leakage currents outside the pumping regions.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A direct current miniature and submersible electromagnetic (DC-EM) pump comprising: a rectangular flow duct; a pair of magnets located on opposing sides of said rectangular duct; a pair of electrodes located on opposing sides of said rectangular duct that do not have said magnets; and when a current is applied to said electrodes, an electrically conductive fluid flows through said rectangular duct by using generated Lorentz forces in a direction perpendicular to the magnetic field flux density created by said opposingly located magnets and a DC electrical current created by said electrodes.

2. The direct current miniature and submersible electromagnetic (DC-EM) pump of claim 1 wherein said magnets are arranged to create spaced apart pumping regions.

3. The direct current miniature and submersible electromagnetic (DC-EM) pump of claim 1 wherein said magnets are elongated.

4. The direct current miniature and submersible electromagnetic (DC-EM) pump of claim 1 wherein said magnets are elongated, Alnico 5 permanent magnets having opposing ends.

5. The direct current miniature and submersible electromagnetic (DC-EM) pump of claim 1 wherein said magnets are elongated, Alnico 5 permanent magnets having opposing ends with each end connected to a Hiperco-50 pole piece.

6. The direct current miniature and submersible electromagnetic (DC-EM) pump of claim 4 wherein said rectangular permanent magnets are arranged on said duct to have opposite magnetizing directions.

7. The direct current miniature and submersible electromagnetic (DC-EM) pump of claim 5 wherein said rectangular permanent magnets are arranged on said duct to have opposite magnetizing directions.

8. The direct current miniature and submersible electromagnetic (DC-EM) pump of claim 6 wherein magnetic field lines in said pumping regions extend between the two magnet poles of said magnets and across said flow duct in a perpendicular direction to both those of the electric current and induced liquid flow.

9. The direct current miniature and submersible electromagnetic (DC-EM) pump of claim 7 wherein magnetic field lines in said pumping regions extend between the two magnet poles of said magnets and across said flow duct in a perpendicular direction to both those of the electric current and induced liquid flow.

10. The direct current miniature and submersible electromagnetic (DC-EM) pump of claim 8 wherein the length of said pumping regions equals that of said current electrodes.

11. The direct current electromagnetic (DC-EM) pump of claim 9 wherein the length of said pumping regions equals that of said current electrodes.

12. The direct current miniature and submersible electromagnetic (DC-EM) pump of claim 10 wherein the electrical currents in said pumping regions are supplied in opposite directions so that the generated Lorentz force act in the flow direction.

13. The direct current miniature and submersible electromagnetic (DC-EM) pump of claim 11 wherein the electrical currents in said pumping regions are supplied in opposite directions so that the generated Lorentz force act in the flow direction.

14. The direct current miniature and submersible electromagnetic (DC-EM) pump of claim 8 wherein the length of said flow duct between said pumping regions equals the separation distance between said current electrodes.

15. The direct current miniature and submersible electromagnetic (DC-EM) pump of claim 9 wherein the length of said flow duct between said pumping regions equals the separation distance between said current electrodes.
